(19) United States
(12) Patent Application Publication
(10) Pub. No.: US 2003/0145278 A1
(43) Pub. Date: Jul. 31, 2003

(54) Method and system for comparing structured documents

(76) Inventor: Andrew S. Nielsen, Redmond, WA (US)

Correspondence Address: HEWLETT-PACKARD COMPANY, Intellectual Property Administration, P.O. Box 272400, Fort Collins, CO, 80527-2400, US

(21) Appl. No.: 10/055,253

(22) Filed: Jan. 22, 2002

(51) Int. Cl. G06F 17/00

(52) U.S. Cl. 715/511

(57) ABSTRACT

A method and system for comparing a first document and a second document. First, at least one compare attribute is inserted into either the first document or the second document. Second, the first document is compared with the second document in a manner based on the compare attribute. For example, the compare attribute can include an ignore element attribute, an ignore attribute attribute, and an unordered attribute.

### FIELD OF THE INVENTION

The present invention relates generally to the comparing documents, and more particularly, to a method and system for method and system for comparing structured documents.

### BACKGROUND OF THE INVENTION

Recent years have seen an increase in the popularity of mark-up languages. The mark-up languages provide tags that provide order or structure to a document. These markup languages provide a cross-platform approach to data encoding and formatting.

An example of a familiar mark-up language is the hypertext markup language (HTML) that is utilized by web browsers to display web pages. Another markup language that is growing in popularity is the extensible markup language (XML).

The extensible markup language (XML) consists of elements, attributes, and text. Examples of these are now described. An empty element may be represented by “<TagName/>” or “<TagName></TagName>”. An attribute in an empty element may be represented by “<TagName AttrName=“attr value”/>”. An element that contains text may be represented by “<TagName>The text</TagName>”.

An integral part of XML is its containment relationship. Elements contain attributes and other elements. In the example “<Tag1 Attr1=“value 1”><Tag2/></Tag1>”, the element “Tag1” contains an attribute “attr1” and an element “Tag2”. Attributes contain only text values. It is noted that there is no limit on the number of contained elements or the depth of containment. Attributes that are contained in an element are required to have unique names, but elements do not share this restriction.

An XML document has only one root element. There are also certain rules about how and where to use special characters, such as the “<”, “>”, and “/” characters. When elements do not contain text or other elements, the elements can have the form: “<TagName/>” or “<TagName></TagName>”. Elements that have contents are of the form: “<TagName>contents</TagName>”. The first tag is called the beginning tag, and the second tag is called the ending tag.

Tag names must match exactly according to character and case. Text may not contain “<” or “&” characters. When one these characters are desired, the symbols “&gt;” and “&amp;” respectively, may be employed.

When documents abide by these rules, the documents are referred to as “well-formed” documents. FIGS. 3A and 3B illustrate examples of XML documents that represent a recipe. It should be noted that the foregoing is a brief explanation of the major components of XML. For further details about XML the reader is referred to the following website address: http://www.w3.org/TR/2000/REC-xml-20001006.

There are many applications where the comparison of two XML documents is required. One such application is the testing of XML based services (e.g., SOAP-based services) offered by a server. The most practical way to test these services is to generate request messages and expected response messages. Testing infrastructures use these request/response pairs to test a target server. The request is sent to a target server, and an actual response is returned. At this point in the testing, the actual response is compared to the expected response to determine if the operation (e.g., a write operation) has executed as expected. The actual response and expected response are typically in the form of a mark-up language document (e.g., an XML document).

XML Document Comparison

Unfortunately, XML documents are difficult to compare. One prior approach for comparing XML documents involves comparing the text in a character-by-character fashion. This prior art approach is not very accurate because XML documents often contain ignorable white-space characters, such as space, tab, new-line, or carriage return. The presence of these white-space characters may vary making the textual comparison fail when for all practical purposes the documents are the same.

In the example above the document was formatted with new-lines and tabs to make it easier to read, but the document could have just as easily been represented as “<Recipes><Recipe author= . . . ” and it would be the “same” document.

Another prior art approach for comparing XML documents involves the removal of the white-space characters prior to textual comparison. Although this approach solves the white-space problem, there are other aspects of comparing XML documents that are problematic for prior art approaches.

Another challenge in comparing XML documents is that attributes of XML documents are always unordered. The removal of white space does not address or solve this problem. For example, the XML “<Tag attr1=“one” attr2=“two”/>” is equivalent to “<Tag attr2=“two” attr1=“one”/>”. Consequently, it is desirable for there to be a comparison mechanism that addresses the challenge posed by the unordered attributes.

One approach to solve the unordered attribute problem is to order the attributes alphabetically before comparing the documents. Unfortunately, this alphabetical ordering is difficult to perform. For example, text fragments need to be moved around in order to accomplish this alphabetical process.

Another challenge that faces prior art comparison techniques is that often times XML containers contain lists of elements, where the order does not matter. For example, the order of the ingredients in the ingredient list is not important, provided that all the ingredients are present.

However, in certain cases, the order of elements is important. For example, in the process element, the steps in the process are order-dependent. One cannot mix the ingredients until all the ingredients have been combined. In this case, a comparison algorithm is required to compare the elements in an ordered fashion.

Another challenge that faces prior art comparison techniques is that in certain cases, it is not important to compare the contents of certain attributes or elements. Consequently, it is desirable to have a mechanism to ignore these attributes and elements. Unfortunately, the prior art approaches do not have such a mechanism.

To summarize, there are many challenges to comparing XML documents in an accurate and efficient manner. These challenges include, but are not limited to, ignorable white-spaces, attributes that are unordered, a mechanism is needed to define if the contained elements are ordered or unordered, a mechanism is needed to define which attributes are to be ignored, and a mechanism is needed to define which elements are to be ignored.

Based on the foregoing, there remains a need for a method for comparing structured documents that overcomes the disadvantages set forth previously.

### SUMMARY OF THE INVENTION

According to one embodiment, a method and system for comparing a first document and a second document are described. First, at least one compare attribute is inserted into either the first document or the second document. Second, the first document is compared with the second document in a manner based on the compare attribute. For example, the compare attribute can include an ignore element attribute, an ignore attribute attribute, and an unordered attribute.

Other features and advantages of the present invention will be apparent from the detailed description that follows.

### BRIEF DESCRIPTION OF THE DRAWINGS

The present invention is illustrated by way of example, and not by way of limitation, in the figures of the accompanying drawings and in which like reference numerals refer to similar elements.

FIG. 1 illustrates a document comparison mechanism according to one embodiment of the present invention.

FIG. 2 is a flow chart illustrating the steps performed by the document comparison mechanism of FIG. 1 in accordance with one embodiment of the present invention.

FIGS. 3A and 3B illustrate a first and second exemplary documents.

FIG. 4 illustrates how the ignore element attribute is used by document comparison mechanism according to one embodiment of the present invention.

FIG. 5 illustrates how the ignore attribute attribute is used by document comparison mechanism according to one embodiment of the present invention.

FIG. 6 illustrates how the unordered attribute is used by document comparison mechanism according to one embodiment of the present invention.

### DETAILED DESCRIPTION

A method and system for comparing structured documents (e.g., documents described by a markup language) are described. In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

Document Comparison Mechanism 110

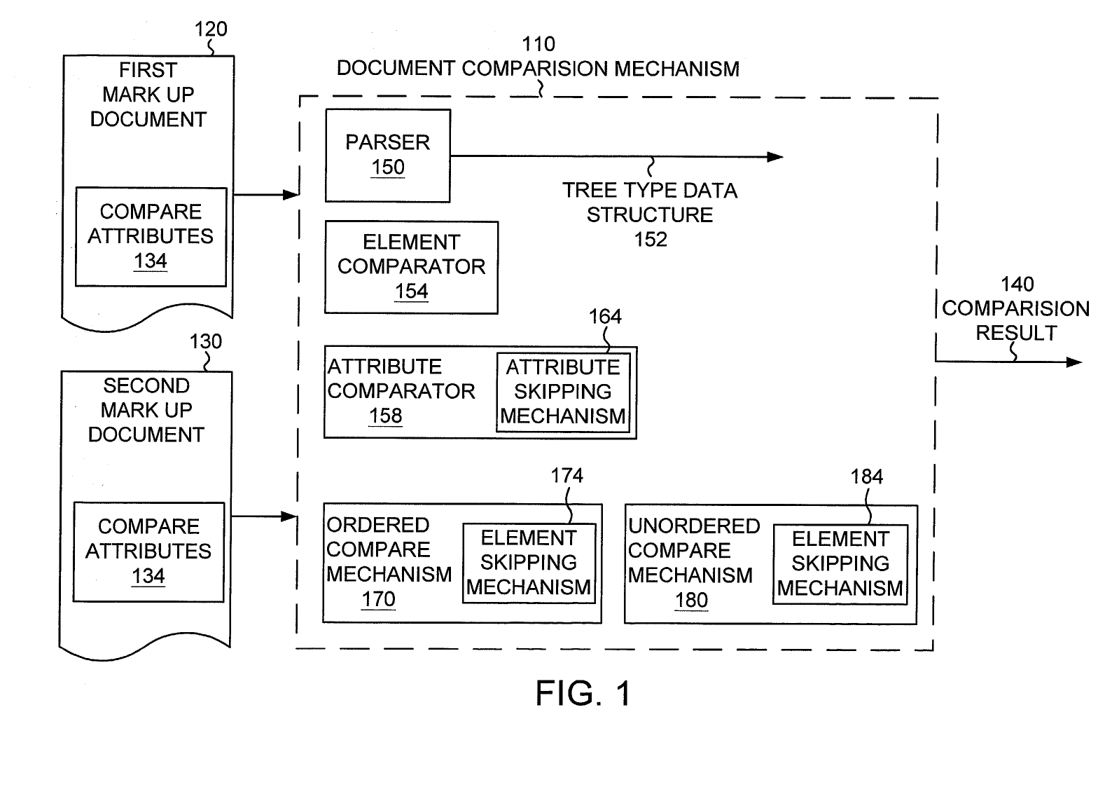

FIG. 1 illustrates a document comparison mechanism (DCM) 110 according to one embodiment of the present invention. The document comparison mechanism (DCM) 110 receives a first markup document 120 and a second markup document 130 Based on the first markup document 120 and the second markup document 130, the DCM 110 generates a comparison result 140. The comparison result 140, for example, can specify whether the first markup document 120 and a second markup document 130 are the same or different.

One advantage of the document comparison mechanism (DCM) of the present invention is that the comparison is robust and accurate. The comparison is robust and accurate in that the document comparison mechanism (DCM) of the present invention handles the challenges of white spaces, well-formed issues, and attribute ordering described previously.

Another advantage of the document comparison mechanism of the present invention is that the comparison mechanism is flexible. The document comparison mechanism is flexible in that the DCM allows a user to control the details of the comparison and to tailor a particular comparison to the needs of a specific application. The DCM provides tags for use by a user to modify what elements or attributes of a document are compared and also to modify whether a comparison requires a specific order.

For example, ignore element tags, ignore attribute tags, and unordered tags are provided so that a user can use these tags to specify which elements, attributes, and the order thereof are important for a particular comparison. In this manner, the document comparison mechanism (DCM) of the present invention provides a flexible comparison scheme that can be tailored to suit the needs of a particular application.

The first markup document 120 and the second markup document 130 can be, for example, XML documents. The first markup document 120 or the second markup document 130 can include compare attributes 134 for facilitating the comparison of the documents. As described in greater detail hereinafter, the compare attributes 134 are decoded by the DCM 110 and used by the DCM 110 to flexibly modify the comparison processing.

One aspect of the present invention is the provision of comparison tags that may be added to one of the documents being compared. These tags, which are described in greater detail hereinafter, facilitate the comparison process. For example, tags may be added to a first structured document (e.g., an expected response document) so that the first structured document can be compared with a second structured document (e.g., an actual response document) in an efficient and flexible manner.

The document comparison mechanism 110 includes a parser 150 for receiving the first markup document 120 and the second markup document 130 and based thereon for generating internal representations thereof. Preferably, the parser 150 generates a tree type data structure 152 to represent the documents (e.g., 120, 130) to be compared.

For example, when this internal representation is a document object model (DOM), the parser 150 preferably includes a Document Object Model (DOM) parser that parses XML documents and based thereon generates DOM representations thereof. The DOM parser 150 handles well-formed issues, attribute ordering, and white spaces. Specifically, the parser 150 ignores white spaces, orders the attributes, and ensures that the documents (e.g., the expected response document and actual response document) are well formed.

The document comparison mechanism 110 also includes an element comparator 154 for comparing the elements of the first markup document 120 and the second markup document 130.

The document comparison mechanism 110 also includes an attribute comparator 158 for comparing the attributes of each element in the documents. The attribute comparator 158 includes an attribute skipping mechanism (ASM) 164 for selectively skipping attributes (i.e., not comparing certain attributes) that are identified by an ignore attribute tag. The ignore attribute tag is described in greater detail hereinafter.

The document comparison mechanism 110 also includes an ordered compare mechanism 170 for performing an ordered compare of elements of the documents and an unordered compare mechanism 180 for performing an unordered compare of elements of the documents.

The ordered compare mechanism 170 includes an element skipping mechanism (ESM) 174 for selectively skipping elements (i.e., not comparing certain elements) that are identified by an ignore element tag. Similarly, the unordered compare mechanism 180 includes an element skipping mechanism (ESM) 184 for selectively skipping elements (i.e., not comparing certain elements) that are identified by an ignore element tag. The ignore element tag is described in greater detail hereinafter.

Compare Attributes

One aspect of the present invention is to define several compare attributes (also referred to herein as compare tags) that have a special meaning to a comparison algorithm. These attributes are included, for example, in elements in the expected response. In this embodiment, the attributes are: 1) compare ignore attributes (cmp:ignoreAttrs); 2) compare ignore elements (cmp:ignoreElts); and 3) compare unordered (cmp:unordered).

The cmp:ignoreAttrs attribute is added to elements that contain attributes that need to be ignored or skipped in the comparison. The cmp:ignoreAttrs attribute's value may be a comma-separated list of attribute names to be ignored during the comparison. If the value is empty, all attributes are ignored. If the attribute is not present on an element, no attributes are ignored (i.e., all attributes are compared).

The cmp:ignoreElts attribute is added to elements that contain elements that need to be ignored. Its value will be a comma-separated list of element names to be ignored. If the value is empty, all elements are ignored. If the attribute is not present on an element, no contained elements are ignored (i.e., all elements are compared).

The cmp:unordered attribute is added to elements to define how contained elements (e.g., children elements) are ordered. When the cmp:unordered attribute has a value of “True”, the contained elements (e.g., immediate children nodes) need not be in the same order as specified in the current document. When the cmp:unordered attribute has a value of not “True”, or when the cmp:unordered attribute is not present in the element, the contained elements must be in the order specified in the expected response.

Processing Steps

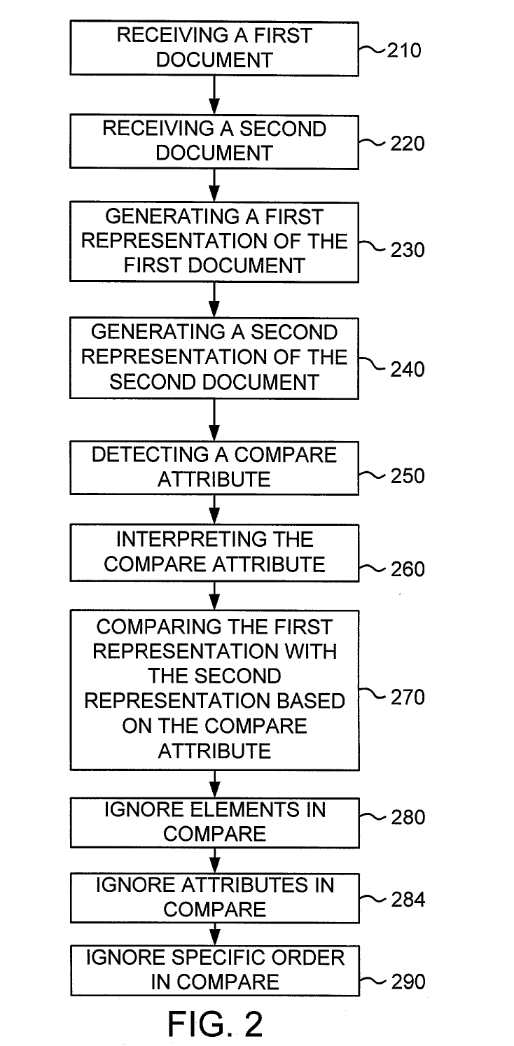

FIG. 2 is a flow chart illustrating the steps performed by the document comparison mechanism of FIG. 1 in accordance with one embodiment of the present invention. In step 210, a first document for comparison is received. In step 220, a second document for comparison is received. At least one of the first document or the second document includes a compare attribute.

For example, the compare attribute can include, but is not limited to, an ignore element attribute, an ignore attribute attribute, and an unordered attribute.

In step 230, a first representation of the first document is generated. In step 240, a second representation of the second document is generated. The first representation of the first document and the second representation may be, for example, an internal representation of the document (e.g., test file or suite). For example, the internal representation may be a data structure (e.g., a XML tree) that represents the document.

In step 250, a compare attribute is detected or read. In step 260, the compare attribute is decoded or interpreted (e.g., by determining whether the attribute is for ignoring elements, ignoring attributes, or ignoring a specific order).

In step 270, the first representation of the first document is compared with the second representation of the second document in a manner based on the compare attribute. Specifically, the comparison is tailored to or dependent upon the compare attributes that are inserted into the first document or the second document. This tailored comparison is referred to hereinafter as a “compare attribute dependent comparison”.

In step 280, the comparison mechanism ignores an element during comparison when the element has an ignore element tag (i.e., the comparison mechanism does not compare elements with the ignore element tag). In step 284, the comparison mechanism ignores an attribute during comparison when the attribute has an ignore attribute tag (i.e., the comparison mechanism does not compare attribute designated with the ignore attribute tag). In step 290, the comparison mechanism ignores a specific order of elements when the elements have an unordered attribute (i.e., the comparison mechanism does not require a specific order of the elements designated with the unordered tag).

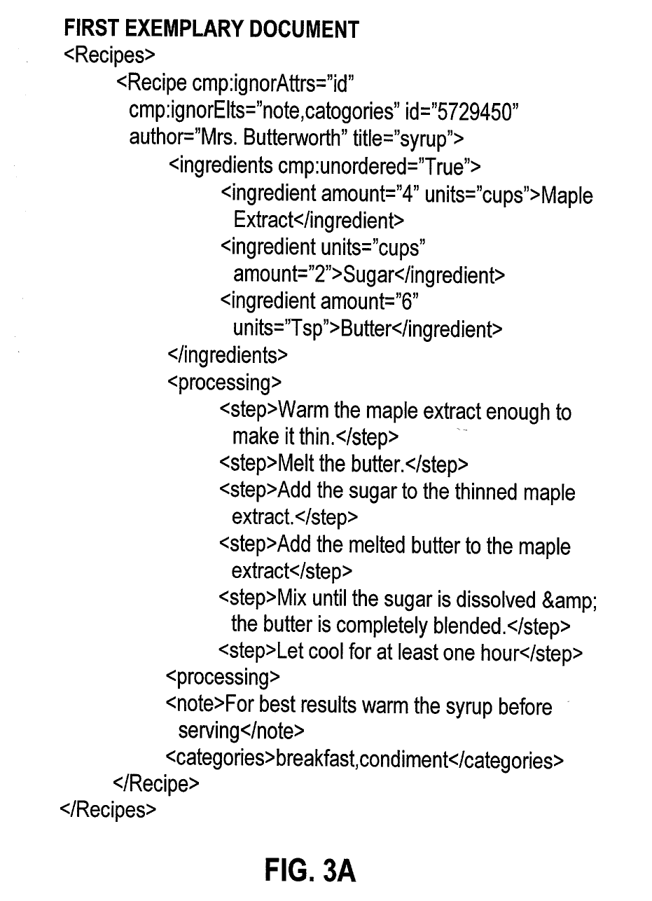

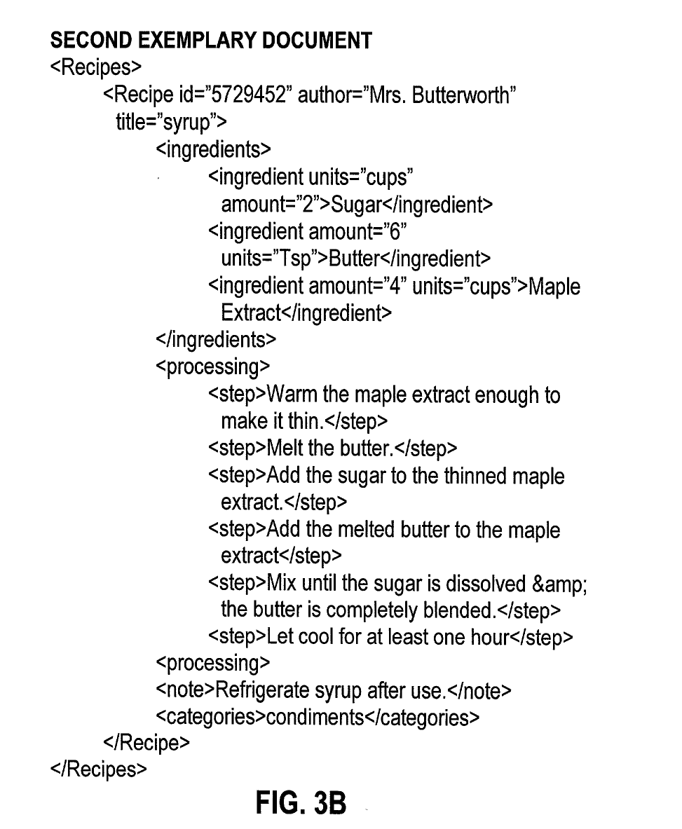

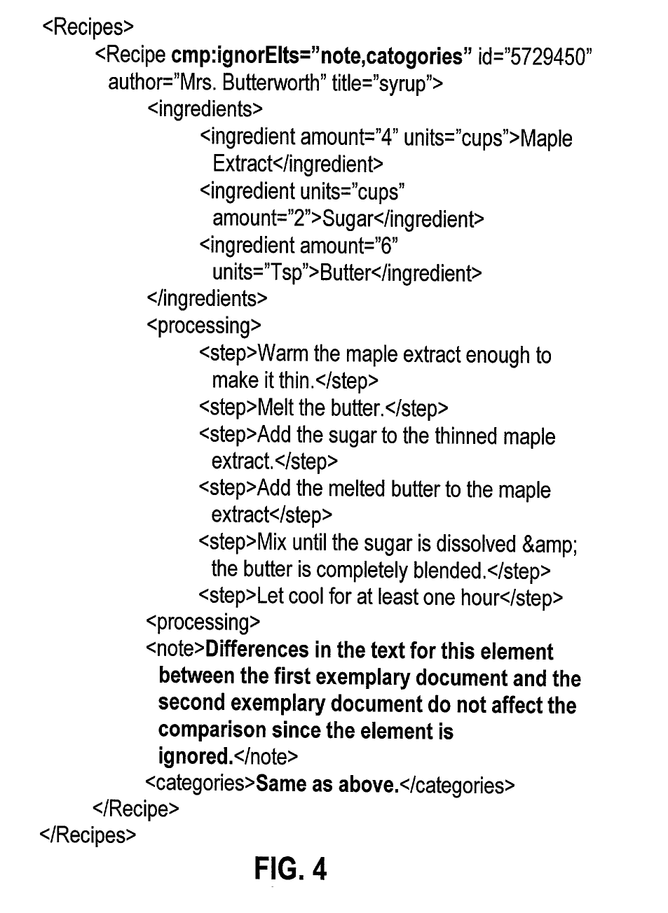

FIGS. 3A and 3B illustrate first and second exemplary documents. FIG. 4 illustrates how the ignore element attribute is used by document comparison mechanism according to one embodiment of the present invention. In this example, the ignore elements attribute specifies the “note” element and the “categories” element. Although the text for the “note” element and the “categories” element differs between the first exemplary document and the second exemplary document, the comparison results in a match because the “note” element and the “categorie” element are ignored in the comparison.

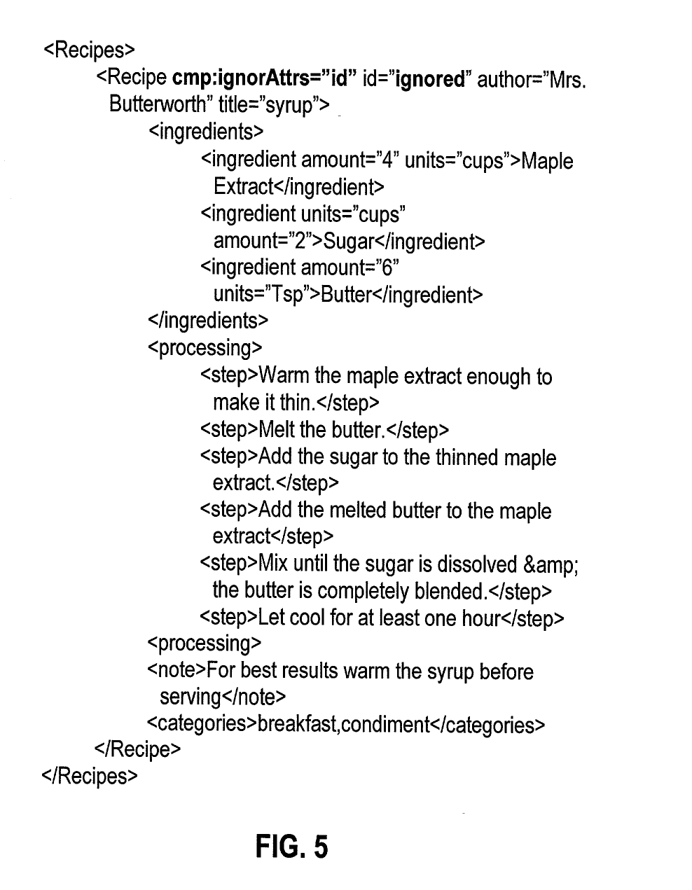

FIG. 5 illustrates how the ignore attribute attribute is used by document comparison mechanism according to one embodiment of the present invention. In this example, the “id” attribute is specified as an attribute to be ignored. Consequently, although the text for the “id” attribute differs between the first exemplary document and the second exemplary document, the comparison results in a match because the “id” attribute is ignored in the comparison.

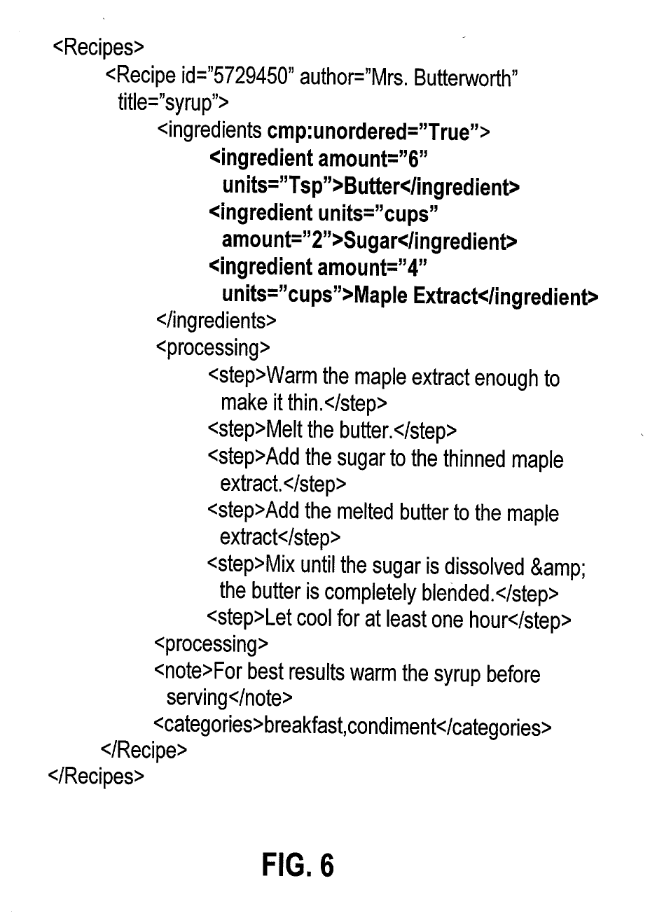

FIG. 6 illustrates how the unordered attribute is used by document comparison mechanism according to one embodiment of the present invention. In this example, when the “cmp:unordered” attribute is true, the order of the “Butter”, “Sugar”, and “Maple Extrac” ingredients is ignored during the comparison.

Web Service Testing Application

Testing of web services is problematic in many ways. One of the problems faced by testers of XML documents based web services is that often the information returned from a request can not be determined at the time the tests are created.

For example, a web service may support the saving of some object. The service often assigns the object a key, tracking number, or other such value. The service also provides a way to look up the object. The testing of this service requires the test infrastructure to have the ability to save the item in the first step, and when successful, lookup the just saved item in the second step. This second step verifies the operation of the first step, thereby ensuring that the save operation performed in an accurate fashion.

In one embodiment, the mechanism of the present invention is implemented within an XML test infrastructure. For example, in testing UDDI servers, “save” calls return the same form of information that is returned by the “get” calls. To test whether a “save” request is successful, one first performs a “save” request followed by a “get” request. In this manner, the information that is saved by UDDI server in response to the “save” request may be compared to the information provided by the server in response to a “get” request.

In an example that is unrelated to UDDI, a recipe server expects to receive requests that have the form: “<save><recipes> . . . </save>”. In response, the recipe server returns: <recipes> . . . ” that may have a few extra elements and attributes.

The recipe server is responsible for generating and returning the id attribute and the categorize element. In order to test such a recipe server, the test defines a request/expected response pair. The request includes a save element containing the recipes from the example above without the id attribute and the categorize element (which are values generated by the server). The expected response is the recipes from the example above.

The test code sends the request and receives an actual response. At this point, the actual response needs to be compared with the expected response. Clearly, the prior art approaches, described previously, are insufficient for this task.

These prior art approaches fail because the expected response cannot know the identification number (id) or the categorize values until the request completes. In this regard, the present invention provides a mechanism for ignoring these values in the actual response. Also, the expected response cannot know the order of the ingredients in the actual response. In this regard, the present invention provides a mechanism for relaxing the ordered comparison of different element nodes.

Preferably, the algorithm is a recursive one that takes two DOM Element parameters (expected and actual). Pseudocode is now provided to further describe the comparison method of the present invention that utilizes one or more of the comparison tags described previously.

The function compareElt (expected, actual) compares the tagname of each element. When the tagname is not the same, a “not equal” is returned. The function compareElt calls the CompareAttrs(expected, actual) function. When a cmp:unordered has been detected, and cmp:unordered is true the UnorderedCompareContents(expected, actual) function is called.

Otherwise, the OrderedCompareContents(expected, actual) function is called. When the text for both documents is not the same, a “not equal” is returned. Otherwise, an “equal” is returned.

The function compareAttrs(expected, actual) ensures that for every attribute in a first document (e.g., expected) there is a corresponding attribute in a second document (e.g., actual) with the same name and value. The function compareAttrs(expected, actual) also ensures that for every attribute in the second document (e.g., actual) there is a corresponding attribute in the first document (e.g., expected) where the name and values are equal or the same. During the comparison, any attributes that begin cmp: and-any attribute in the cmp:ignoreAttrs list of attribute names is ignored.

The function UnorderedCompareContents(expected, actual) ensures that for every element in the first document (e.g., the expected) there is a corresponding element in the second document (e.g., the actual) where compareElt(expected.child, actual.child) returns equal. The function UnorderedCompareContents(expected, actual) further ensures that for every element the second document (e.g., the actual) there is a corresponding element in the first document (e.g., the expected) where compareElt(expected.child, actual.child) returns equal. During the comparison, any elements that are in the cmp:ignoreElts list of element names are ignored.

The function OrderedCompareContents(expected, actual) steps through the list of elements in the first document and the second document (e.g., the expected and actual) and ensures that compareElt(expected.child, actual.child) returns equal. During this process, elements in the cmp:ignoreElts list of element names are ignored.

Exemplary psudocode for one implementation of the compare method according to one embodiment of the present invention is now described.

Function compareElt (expected, actual)

if actual.tagname != expected.tagname

RETURN not equal

CompareAttrs(expected, actual)
if expected contains cmp:unordered that is true

UnorderedCompareContents(expected, actual)

Otherwise

OrderedCompareContents(expected, actual)

if actual.test != expected.text

RETURN not equal

RETURN equal

End
Function compareAttrs (expected, actual)

ignoreAttrs = expected's “cmp:ignoreAttrs” attribute's value
for each ignoreAttrName in ignoreAttrs do

remove the attribute in expected with name equal to
ignoreAttrName
remove the attribute in actual with name equal to
ignoreAttrName

end for
actualList = a new list of all attributes in actual
for each expectedAttr in expected do

if expectedAttr is a “cmp:” attribute OR if expectedAttr is the
“xmlns:cmp” attribute, then

continue with next attribute

else
actualAttr = actualList's attribute with the same name as

expectedAttr's name

if no such attribute exists in actualList, then

RETURN not equal

else

if actualAttr's value = expectedAttr's value, then

remove actualAttr from actualList
continue with next attribute

else

RETURN not equal

end if

end if

end if

end for
if actualList still contains attributes, then

RETURN not equal

endif
Function UnorderedCompareContents (expected, actual)

ignoreElts = expected's “cmp:ignoreElts” attribute's value
for each ignoreEltName in ignoreElts do

remove all elements in expected with tag name equal to

ignoreEltName
remove all elements in actual with tag name equal to ignoreEltName

end for
actualList = a new list of all nodes in actual
for each expectedChild that is a child of expected do

for each actualChild in actualList do

compareElt(expectedChild, actualChild)
if compareElt above returned not equal, then

continue with next actualChild in actualList

else

remove actualChild from actualList
continue with next expectedChild that is a child of
expected

end if

end for
RETURN not equal

end for
if actualList still contains nodes, then

RETURN not equal

endif
Function OrderedCompareContents (expected, actual)
ignoreElts = expected's “cmp:ignoreElts” attribute's value
for each ignoreEltName in ignoreElts do

remove all elements in expected with tag name equal to

ignoreEltName

remove all elements in actual with tag name equal to ignoreEltName

end for
actualList = a new list of all nodes in actual
for each expectedChild that is a child of expected do

actualChild = actualList's first element
if no such element exists in actualList, then

RETURN not equal

else

compareElt(expectedChild, actualChild)
if compareElt above returned not equal, then

RETURN not equal

else

remove actualChild from actualList
continue with next element

end if

end if

end for
if actualList still contains nodes, then

RETURN not equal

endif

It is noted that certain details have been omitted in the algorithm set forth above in order not to unnecessarily obscure the teachings of the present invention. These details are related to the handling of the DOM in addition to text comparison, attributes value comparison, and elements.

For the sake of simplicity, these unimportant details have been omitted. It is noted that the DOM structure is object-oriented and can treat text, attribute, and elements in a similar fashion is many respects, thereby enabling an elegant solution.

The principles of the present invention are described in the context of comparing XML documents for a test application. However, it is noted that the teaching of the present invention can be applied to any structured document (e.g., any markup language) and other applications. The markup languages can include, but is not limited to, XML, HTML, SGML, WML, and XHTML Moreover, although the comparison mechanism of the present invention has been described in connection with an application for testing XML based services (e.g., SOAP-based services) offered by a server, it is noted that the comparison mechanism of the present invention can be employed in other applications. These other applications include service performance test applications, and applications that perform continuous operation testing. Outside of the testing arena, there are services that aggregate other services. These aggregate services can employ the comparison method of the present invention to determine the type of incoming request.

One advantage of the present invention is that the mechanism of the present invention allows a user to specify which elements and attributes are unimportant to a particular comparison.

Another advantage of the present invention is that the mechanism of the present invention allows a user to specify when the order of elements to be compared is important and when the order of elements to be compared is unimportant.

Other advantages of the DCM of the present invention include ensuring well-formed XML documents, and ignoring white spaces, handling unordered attributes.

Further advantages of the DCM of the present invention include allowing a user to define or specify whether contained elements are ordered or unordered in a comparison, allowing a user to define or specify which attributes are to be ignored in a comparison, and allowing a user to define or specify which elements are to be ignored in a comparison.

In the foregoing specification, the invention has been described with reference to specific embodiments thereof. It will, however, be evident that various modifications and changes may be made thereto without departing from the broader scope of the invention. The specification and drawings are, accordingly, to be regarded in an illustrative rather than a restrictive sense.

What is claimed is:

1. A method for comparing a first document and a second document comprising the steps of:
inserting at least one compare attribute into one of the first document and the second document; and
comparing the first document and the second document in a manner based on the compare attribute.

2. The method of claim 1 wherein the step of inserting at least one compare attribute into one of the first document and the second document includes the step of
inserting one of an ignore element attribute, an ignore attributes attribute, and an unordered attribute.

3. The method of claim 1 wherein the step of inserting at least one compare attribute into one of the first document and the second document includes the step of
inserting an ignore element attribute;
wherein the step of comparing the first document and the second document in a manner based on the compare attribute includes the step of
when comparing the first document and the second document, ignoring the elements specified by the ignore element attribute.

4. The method of claim 1 wherein the step of inserting at least one compare attribute into one of the first document and the second document includes the step of
inserting an ignore attribute attribute;
wherein the step of comparing the first document and the second document in a manner based on the compare attribute includes the step of
when comparing the first document and the second document, ignoring the attributes specified by the ignore attribute attribute.

5. The method of claim 1 wherein the step of inserting at least one compare attribute into one of the first document and the second document includes the step of
inserting an unordered attribute;
wherein the step of comparing the first document and the second document in a manner based on the compare attribute includes the step of
when comparing the first document and the second document, ignoring the order of the elements specified by the unordered attribute.

6. The method of claim 1 wherein the step of comparing the first document and the second document in a manner based on the compare attribute includes the step of
parsing the first document to generate an first internal representation thereof;
parsing the second document to generate an second internal representation thereof;
comparing non-tagged elements of the first internal representation and the second internal representation;
comparing non-tagged attributes for each element; and
comparing child nodes in a non-ordered manner when a non-ordered tag is set to true in the parent node.

7. The method of claim 1 wherein the step of comparing the first document and the second document in a manner based on the compare attribute includes the step of
searching for a unordered attribute;
when an unordered attribute is not detected or an unordered attribute has a first predetermined value, performing a comparison between the first document and the second document; wherein the order of the elements is considered in the comparison;
when an unordered attribute has a second predetermined value, performing a comparison between the first document and the second document; wherein the order of the elements is not considered in the comparison.

8. The method of claim 1 wherein the first document and the second document include documents in a markup language.

9. The method of claim 8 wherein the markup language is one of XML, HTML, SGML, WML, and XHTML.

10. A method for comparing an expected response and an actual response, the expected response including at least one node that includes an ignore element attribute comprising the steps of:
composing an expected response that includes at least one node that includes an ignore element attribute;
when comparing the nodes of the expected response with the nodes of the actual response, skipping those element nodes specified by the ignore element attribute of a parent node.

11. The method of claim 10 further comprising the steps of:
composing an expected response that includes at least one node that includes an ignore attribute attribute;
when comparing the nodes of the expected response with the nodes of the actual response, skipping those attributes specified by the ignore attribute of a current node.

12. The method of claim 10 further comprising the steps of:
composing an expected response that includes at least one node that includes an unordered attribute;
wherein the step of comparing the first document and the second document in a manner based on the compare attribute includes the step of
when comparing the first document and the second document, ignoring the order of the elements specified by the unordered attribute.

13. A test infrastructure for interacting with a server that has capabilities comprising:
a) a test suite for use in testing the capabilities of the server; wherein the test suite includes an expected response for a first request and at least one reference to information not known to a tester when preparing the test suite;
b) an injection module for receiving information from the server, for generating an actual response based on the received information, and for replacing the reference with a target in the actual response that is referenced by the reference; and
c) a comparison module for comparing an actual response with an expected response.

14. The system of claim 13 wherein the comparison module includes
a compare elements module for selectively comparing elements in the documents to be compared based an ignore element attribute.

15. The system of claim 13 wherein the comparison module includes
a compare attributes module for selectively comparing attributes in each of the elements based on an ignore attribute attribute.

16. The system of claim 13 wherein the comparison module further includes
an ordered handling module for performing a comparison that considers the order of the elements.

17. The system of claim 13 wherein the comparison module further includes
an un-ordered handling module for performing a comparison that does not consider the order of the elements when an unordered attribute is present.

18. The system of claim 13 wherein the comparison module further includes
an element skipping mechanism for skipping elements specified in an ignore element attribute during comparison.

19. The system of claim 13 wherein the comparison module further includes
an attribute skipping mechanism for skipping attributes specified in an ignore attributes attribute during comparison.
